(19) United States
(12) Patent Application Publication
(10) Pub. No.: US 2008/0195355 A1
(43) Pub. Date: Aug. 14, 2008

(54) Trainable Sensors and Network

(76) Inventors: Robert Kurt Brandt, Hubertus, WI (US); Mark Stephen Williamsen, Milwaukee, WI (US)

Correspondence Address: MICHAEL BEST & FRIEDRICH LLP, 100 E WISCONSIN AVENUE, Suite 3300, MILWAUKEE, WI, 53202, US

(21) Appl. No.: 11/995,249

(22) PCT Filed: Jul. 11, 2006
(86) PCT No.: PCT/US06/27004

§ 371 Date: Apr. 22, 2008

Related U.S. Application Data
(60) Provisional application No. 60/698,230, filed on Jul. 11, 2005.

(51) Int. Cl. G06F 19/00

(52) U.S. Cl. 702/188

(57) ABSTRACT

A monitoring system (10) includes at least one sensor (12, 100, 102, 104, 106) configured to monitor at least one of sound, light, temperature, pressure, humidity, biological, anabolic, and anatomic data. The sensor (12, 100, 102, 104, 106) is connected to a controller (14) configured to control operation of the sensor (12, 100, 102, 104, 106) such that the sensor (12, 100, 102, 104, 106) is trainable to alert conditions and events. Preferably, the sensor (12, 100, 102, 104, 106) and controller (14) are interconnected to a plurality of sensors (12, 100, 102, 104, 106) so that a number of values associated with the data of interest are acquirable. Preferably, the acquired data is stored and categorized to enhance the operability and functionality of the sensor (12, 100, 102, 104, 106).

### CROSS-REFERENCE TO RELATED APPLICATIONS

The present application claims priority to U.S. Provisional Patent Application Ser. No. 60/698,230 filed on Jul. 11, 2005, the entirety of which is expressly incorporated herein by reference.

### BACKGROUND OF THE INVENTION

1. Field of the Invention

The present invention relates to the field of remote monitoring, and more particularly to sensors constructed to adapt to monitor environmental conditions as well as a system of connecting a plurality of sensors to provide an interconnected monitoring array.

2. Background

It is known to remotely monitor environmental conditions and parameters. Environmental parameters associated with weather conditions such as temperature, pressure, and precipitation are frequently remotely monitored through a plurality of sensors positioned at remote monitoring facilities. Each of the remote monitoring devices communicates the sensed data to a central facility where an operator or other system synthesizes the collected data into a report associated with the weather events in the area being monitored. The remotely located sensors are frequently configured to monitor a single parameter and are frequently costly to manufacture, operate, and maintain. Although such systems are widespread and monitor weather conditions across diverse geographic areas, these systems are incapable of monitoring human effective events such as malicious, militant, and/or natural biological events such as the spread of disease.

With the advent of efficient travel modalities such as land, marine, and air vehicles, it is relatively efficient to transport large and small amounts of goods, materials, information, and personnel over great and short distances. Such modalities as well as predictable weather conditions also provide an efficient means of communicating and directing environmental hazards quickly and efficiently. That is, it has become comparatively easy for militant minded individuals to tailor bio-hazardous materials for dissemination in an intended direction and with a predetermined effective area. In order to combat the effects of such dissemination or to prevent such disseminations, preventative measures have been attempted.

Such measures generally include widely associated checkpoints and detectors. Implementation of such a counter-terrorism measure is often time consuming, costly, logistically complex, and only marginally effective. That is, current sensor and detector configurations generally include a sensor configured to detect a predetermined characteristic. For example, sensors are available which can detect the presence of alcohol-based materials but the sensors are ill equipped to detect and/or distinguish between different types of alcohol-based materials. Understandably, there are naturally occurring and/or derivative materials which are detectable but non-threateningly associated with the intended target material. As such, such detector systems frequently alert threat conditions where no threat actually exists but a derivative of the threatening material is present. That is, such systems occasionally provide false positive alert conditions. Alerting false positive conditions undermines the reliability of the hazard detection system. That is, operators who are frequently subjected to false positive alerts may have a tendency to disregard future actual alert conditions as false positives. Furthermore, the number of false positive alerts erodes the efficient non-hazardous utilization of the travel, transport, or dispersion modality. Accordingly, it would be desirable to provide a sensor capable of differentiating between variants of general classes of pollutants and/or hazardous materials thereby improving the reliability and the specificity of the sensor system.

It would also be desirable to provide a sensor capable of detecting travel characteristics to a pollutant event. Particularly with bio-hazardous events, knowledge of the direction and travel speed of the pollutant event is frequently critical to event containment, determining an effected area, and to personnel such as first responders. Biological monitoring is also beneficial to non-military activities. In particular, medical facilities would benefit from the collection of data associated with pathogen travel and classification to better combat the spread and diagnosis of disease. Accordingly, it is desired to provide a low cost, dynamic monitoring system capable of configuration for operation in a plurality of environments and operable for detecting a number of parameters.

### SUMMARY AND OBJECTS OF THE INVENTION

By way of summary, the present invention is directed to a sensor system network and a number of sensors operable therewith. The network includes a plurality of interconnected sensors that are configured to monitor a desired parameter. The desired parameter could be any of pressure, temperature, aerosol particle counter, biological particle counter, a biological parameter, and a surface biological parameter, and the like. The information acquired by the sensor is communicated to a central facility where, when a plurality of sensors are interconnected, generates a sensed environment overview indicative of the concentration or value of the desired parameter.

One aspect of the present invention is a monitoring system having a controller and a database connected to the controller. A sensor is connected to the controller and configured to monitor a desired parameter and populate the database with the monitored information. The controller is configured to monitor and adjust operation of the sensor responsive to the information of the database.

According to another aspect of the present invention, a sensor is provided and configured to monitor a desired parameter. The sensor includes an input constructed to power the sensor over an Ethernet and an output connectable to at least one of an Ethernet, the Internet, and an intranet. The sensor includes an identifier configured to identify the sensor among a number of sensors. The sensor output communicates an operating status of the sensor to a network.

Another aspect of the invention includes a sensor having at least one elliptical reflector and at least one source. The source emits radiation that is focused onto a particle probe region. A detector is positioned proximate the reflector and configured to acquire a forward scattering of a particle of interest. Preferably, the particle probe region and the detector are located at the foci of the at least one elliptical reflector.

According to a further aspect of the present invention, a sensor is disclosed that is constructed to monitor a biological particle. The sensor includes a first exciter constructed to fire at a first frequency and a second exciter constructed to fire at a second frequency different than the first frequency. A detector is oriented proximate the first exciter and the second exciter and configured to monitor the fluorescence induced in a target particle.

Another aspect of the present invention includes a sensor system having a metal oxide sensor connected to a processor. The sensor is configured to communicate an output value and a signal range surrounding the output value to the processor. The processor is configured to process the output value and the signal range surrounding the output value to identify gas-phase molecules.

Yet a further aspect of the present invention discloses a sensor having a first exciter configured to generate a first signal proximate an ultraviolet range. The sensor includes a second exciter configured to generate a second signal proximate the ultraviolet range. A pair of photo-sensors are positioned proximate the first and second exciters and configured to acquire a particle emissive energy. A controller synchronizes operation of the emitters and a gating of the photo-sensors to identify a particle. Preferably, the sensor monitors a fluorescent lifetime, a ratio of intensities between the pair of photo-sensors, and a particle size to identify pathogenic and non-pathogenic materials.

The ability to collect unique sensor identifiers, collect transducer electronic datasheets, collect location and time-dependant extensible markup language (XML) formatted data, and provide expert-system analysis in a single package are considered new features. Another aspect of the invention is to provide an apparatus that is ruggedized and reliable, thereby decreasing down time and operating costs. Another object of the invention is to provide an apparatus that has one or more of the characteristics discussed above but which is relatively simple to manufacture and assemble using a minimum of equipment.

These, and other aspects and objects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

A clear conception of the advantages and features constituting the present invention, and of the construction and operation of typical mechanisms provided with the present invention, will become more readily apparent by referring to the exemplary, and therefore non-limiting, embodiments illustrated in the drawings accompanying and forming a part of this specification, wherein like reference numerals designate the same elements in the several views, and in which FIGS. 1-18 illustrate various aspects of the present invention. Specifically,

FIG. 1 shows a monitoring system according to the present invention,

FIG. 2 shows an exemplary controller of the monitoring system shown in FIG. 1,

FIG. 3 shows another embodiment of the monitoring system shown in FIG. 1,

FIG. 4 shows an exemplary segregation of the systems of the sensor and the systems of controller of the monitoring system shown in FIG. 1,

FIG. 5 shows an exemplary communication protocol of the monitoring system shown in FIG. 1,

FIG. 6 shows an exemplary organizational structure of a database of the monitoring system shown in FIG. 1,

FIG. 7 shows the monitoring system shown in FIG. 1 having a plurality of differently configured sensors connected to the system,

FIG. 8-12 show a particle counter sensor of the monitoring system shown in FIG. 7,

FIG. 13 shows biological particle counter sensor of the monitoring system shown in FIG. 7,

FIG. 14 shows the elliptical reflector of the sensor shown in FIG. 13,

FIG. 15 shows a surface biological sensor 104 of the monitoring system shown in FIG. 7,

FIGS. 16-18 show the graphical representation of data acquired with another sensor of the monitoring system shown in FIG. 7.

A clear conception of the advantages and features constituting the present invention, and of the construction and operation of typical mechanisms provided with the present invention, will become more readily apparent by referring to the exemplary, and therefore non-limiting, embodiments illustrated herein. In describing the preferred embodiment of the invention that is illustrated in the drawings, specific terminology will be resorted to for the sake of clarity. However, it is not intended that the invention be limited to the specific terms so selected and it is to be understood that each specific term includes all technical equivalents that operate in a similar manner to accomplish a similar purpose. For example, the word “connected,” “attached,” or terms similar thereto are often used. They are not limited to direct connection but include connection through other elements where such connection is recognized as being equivalent by those skilled in the art.

### DESCRIPTION OF PREFERRED EMBODIMENTS

The present invention and the various features and advantageous details thereof are explained more fully with reference to the non-limiting embodiments described in detail in the following description. Specific embodiments of the present invention are further described by the following, non-limiting examples which will serve to illustrate various features of significance. The examples are intended merely to facilitate an understanding of ways in which the present invention may be practiced and to further enable those of skill in the art to practice the present invention. Accordingly, the examples should not be construed as limiting the scope of the present invention.

One embodiment of the present invention is a monitoring system having a controller and a database connected to the controller. A sensor is connected to the controller and configured to monitor a desired parameter and populate the database with the monitored information. The controller is configured to monitor and adjust operation of the sensor responsive to the information of the database.

According to another embodiment of the present invention, a sensor is provided and configured to monitor a desired parameter. The sensor includes an input constructed to power the sensor over an Ethernet and an output connectable to at least one of an Ethernet, the Internet, and an intranet. The sensor includes an identifier configured to identify the sensor among a number of sensors. The sensor output communicates an operating status of the sensor to a network.

Another embodiment of the invention includes a sensor having at least one elliptical reflector and at least one source. The source emits radiation that is focused onto a particle probe region. A detector is positioned proximate the reflector and configured to acquire a forward scattering of a particle of interest. Preferably, the particle probe region and the detector are located at the foci of the at least one elliptical reflector.

According to a further embodiment of the present invention, a sensor is constructed to monitor a biological particle. The sensor includes a first exciter constructed to fire at a first frequency and a second exciter constructed to fire at a second frequency different than the first frequency. A detector is oriented proximate the first exciter and the second exciter and configured to monitor the fluorescence induced in a target particle.

Another embodiment of the present invention includes a sensor system having a metal oxide sensor connected to a processor. The sensor is configured to communicate an output value and a signal range surrounding the output value to the processor. The processor is configured to process the output value and the signal range surrounding the output value to identify gas-phase molecules.

Yet a further embodiment of the present invention discloses a sensor having a first exciter configured to generate a first ultraviolet energy. The sensor includes a second exciter configured to generate a second ultraviolet energy. A pair of photo-sensors are positioned proximate the first and second exciters and configured to acquire a particle emissive energy. A controller synchronizes operation of the emitters and a gating of the photo-sensors to identify a particle. Preferably, the sensor monitors a fluorescent lifetime, a ratio of intensities between the pair of photo-sensors, and a particle size to identify pathogenic and non-pathogenic materials.

### DETAILED DESCRIPTION

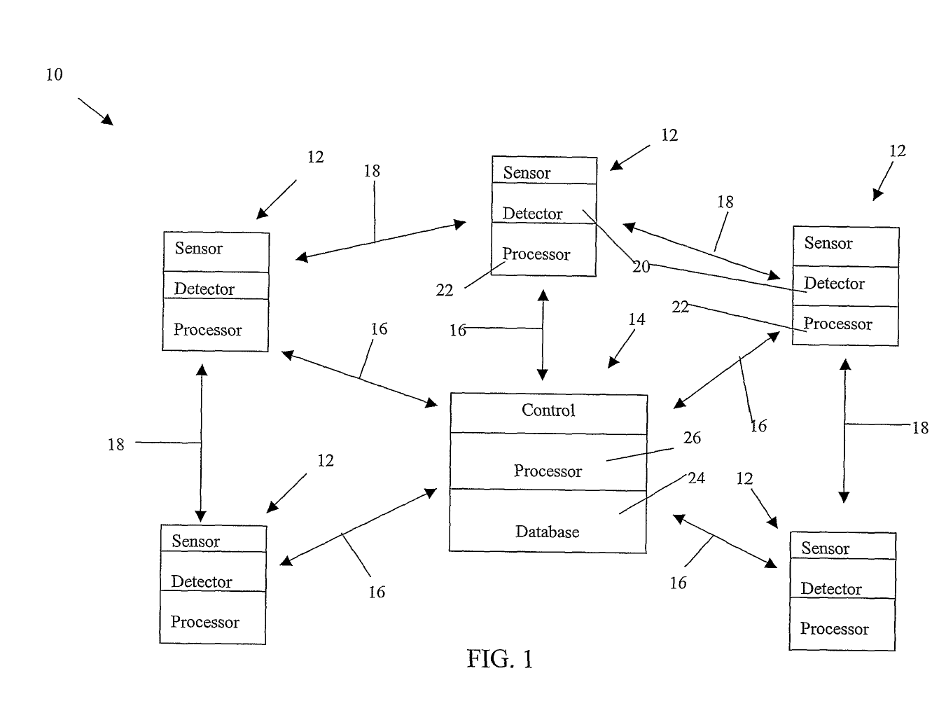

As shown in FIG. 1, a monitoring system 10 includes a number of sensors 12 and a controller 14. A number of communication links 16 allow communication between sensors 12 and controller 14. An optional communication link 18 allows communication between each of the sensors 12 of the system. Understandably, links 16 and 18 may be a physical connection such as a Local Area Network or LAN connection or a wireless communication link generated by the inclusion of a transmitter and receiver in one of the sensor and the controller, respectively. Each sensor 12 includes a detector 20 configured to monitor a desired parameter. A processor 22 is connected to one of sensors 12 and controller 14 and configured to direct operation of detector 20. A database 24 is connected to controller 14 and configured to receive and maintain data acquired by each of the sensors 12 of monitoring system 10. A processor 26 is attached to controller 14 and monitors the operation of controller 14 and database 24. Although shown as separate components, it is appreciated that sensor 12 and controller 14 be integrated into a common device such that the sensor is a fully transportable and self-supporting monitoring device.

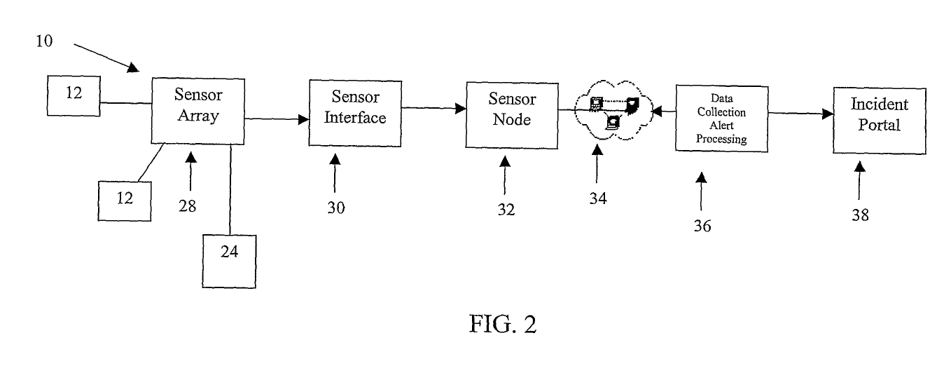

FIG. 2 shows a graphical representation of an exemplary control protocol of monitoring system 10. A sensor array consisting of one or more sensors 12 communicates the information acquired therefrom to an interface or sensor interface 30 and a sensor node 32 into a multiple user system 34. The multiple user system 34 is communicatively connected to a database/processor 36 and configured to monitor in the information acquired by sensor array 28. The system 34 generates an incident report or alert 38 when a target event occurs. Depending on the parameter, the sensor array 28 is configured to monitor the alert may be directed to personnel directly associated with the monitored parameter. That is, if sensor array 28 is configured to monitor biological or chemical adversarial emissions, alert 38 is directed to infield personnel, proximate first responders, or other personnel as may be deemed necessary given the nature of the parameter monitored. Furthermore, the continuous, real-time, non-contact nature of operation of monitoring system 10 allows relatively expedient, inline operation, monitoring, and resolution of alert events. The continued and maintained operation of database 24 allows for the continual and real-time updating of the monitoring of sensors 12 of sensor array 28. Such a configuration allows operational adjustment of the control of sensors 12 during acquisition of information thereby allowing on-the-fly adaptation of sensors 12 to environmental events.

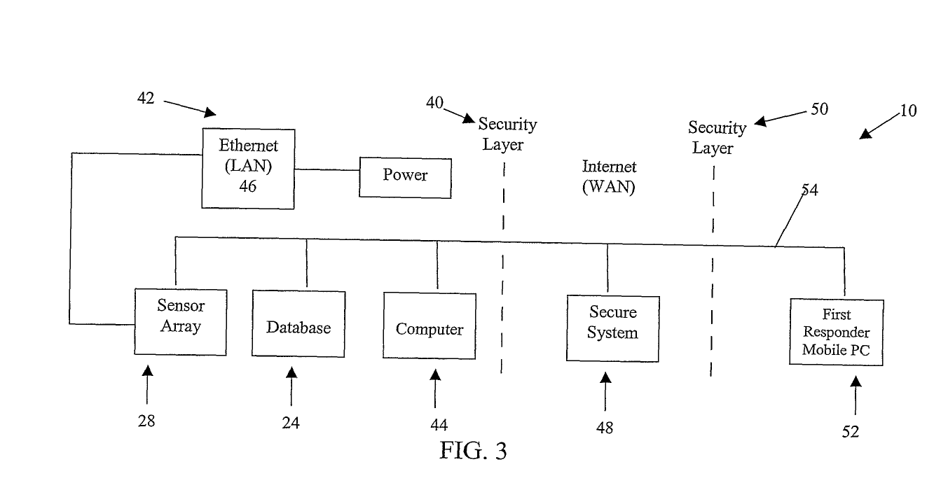

FIG. 3 shows an optional configuration of monitoring system 10. As shown in FIG. 3, a first security protocol 40 prevents unauthorized access to a shielded portion 42 of monitoring system 10. Information is collected by sensor array 28 and communicated to database 24 and accessible thereby at a computer 44. An Ethernet connection 46 connects sensor array 28 to a power source and communicates the information acquired by the sensor array to computer 44. A secured system 48 is connected to computer 44 such that only restricted access is permitted to the information contained on secure system 48. Understandably, all of the information acquired by sensor array 28 could be confined behind security protocol 40. Another security protocol 50 allows communication of instructions from secure system 48 to a remote responder 52 not otherwise in communication with monitoring system 10. That is, only in the event of an alert condition is an instruction sent to remote responder that an alert condition has occurred. Such a construction reduces the personnel monitoring of system 10 and allows relatively uninterrupted operation of system 10 until an alert condition occurs. Although remote responder 52 is shown as connected to secure system 48 via an Internet connection 54, it is understood that other connection modalities such as wireless connection are envisioned and within the scope of the claims.

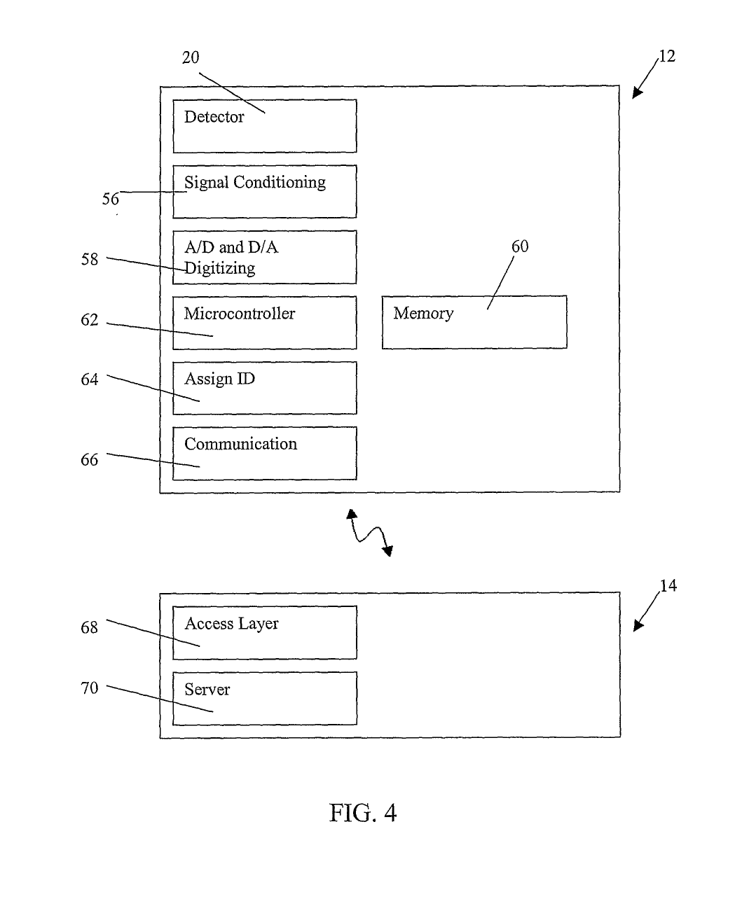

FIG. 4 shows an exemplary segregation of the systems of sensor 12 and the systems of controller 16. A signal generated by detector 20 of sensor 12 is conditioned 56 and digitized 58 from analog (A) to digital (D). The data is stored in memory 60 and a controller or microcontroller 62 formats the stored data into an XML message. Authorization identification (ID) 64 is assigned to the information acquired by sensor 12 to prevent unauthorized acquisition or transmission of the acquired data. A communication device 66 allows for the connection of sensor 12 to the other operation components of monitoring system 10 such as controller 14. Controller 14 includes a reciprocal communication device or access layer 68 that is constructed to communicate with the communication device 66 of sensor 12. Understandably, communication devices 66, 68 are constructed to allow communication between sensor 12 and controller 14 regardless of the modality of the communication interface. That is, if the sensor and the controller are preferred to wirelessly communicate, communication devices 66, 68 are constructed to facilitate wireless communication therebetween. Likewise, if wired communication is desired, communication devices 66, 68 are constructed to allow wired connection of sensor 12 and controller 14. Controller 14 includes a server 70 constructed to control operation and exchange of information between controller 14 and sensor 12. Server 70 also provides for the connection and communication of a plurality of sensor with controller 14.

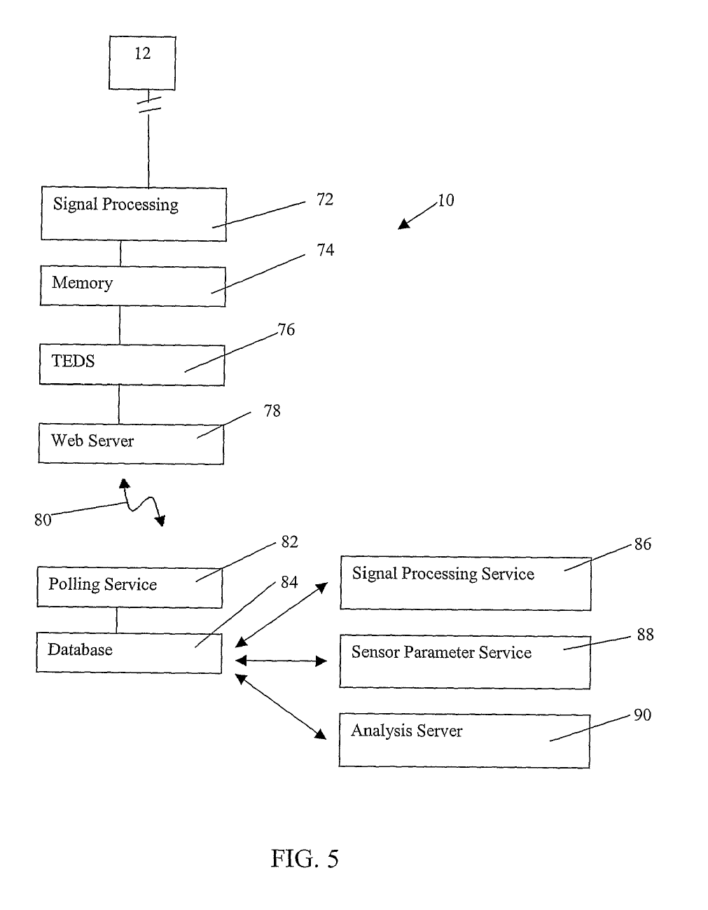

FIG. 5 shows an exemplary communication protocol of monitoring system 10. At least one signal process or, e.g., an algorithm 72 processes data received from sensor 12 and preferably stores the data in a memory module 74. Additionally, where desired, signal-processing algorithm 72 may encode the data acquired by sensor 12 prior to or after storage of the data. A transducer electronic datasheet 76 stores information about sensor 12 which can include sensor calibration and control information. A web server 78 provides a communication interface that allows external viewing, monitoring, manipulating, and polling of the data collected from sensor 12. The sensor collected information, whether encrypted or not, is carried in XML packets transferred through a transmission control protocol/internet protocol or TCP/IP protocol. An optional polling service 82 runs on the server 78 and polls data from the sensors connected to monitoring system 10. The data about the sensors and data from the sensors is stored in a relational database 84 and a signal processing service 86 queries data from database 84 and processes it per a rules-based algorithm as will be described further below. A sensor parameter service 88 maintains updated parameter information from and to the sensors of the monitoring system. An optional analysis server 90 provides system trend analysis of regional datasets and produces alarms based on non-nominal sensor readings and also considers rules-based false-alarm intelligence. Analysis server 90 automatically updates the operation of monitoring system 10 in response to, in part, the operational performance of sensor 12.

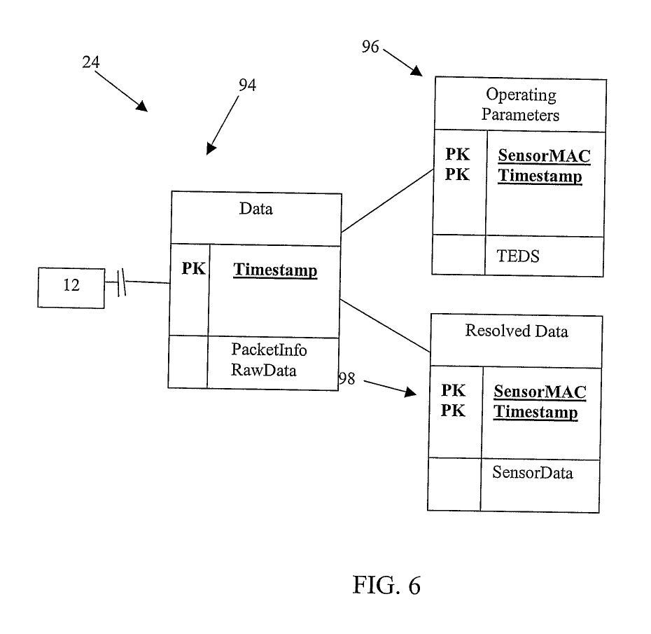

FIG. 6 shows an exemplary organizational structure of database 24. Understandably, database 24 could be any of connected to sensor 12, connected to controller 14, or remote therefrom. Database 24 is preferably continuously in communication with sensor 12 during the acquisition of data to ensure the maximum acquisition of information monitored by sensor 12. Additionally, it is further understood that sensor 12 include a database to allow continued data acquisition and retention even when sensor 12 is not in communication with controller 14. Such a construction allows continued data acquisition until a connection with the sensor is established. The sensor data is collected into a storage area 94 that records a timestamp, network packet information and raw sensor data. Information about the operational parameters of sensors 12 such as test limits or operating ranges is stored in an operating parameters storage area 96 and used to configure sensor 1Z for desired operation and to assess the operating condition of the sensor. After the data acquired by the sensor has been processed, database 24 includes a resolved data table 98 constructed to store the analyzed information as determined by the data acquired by the sensor.

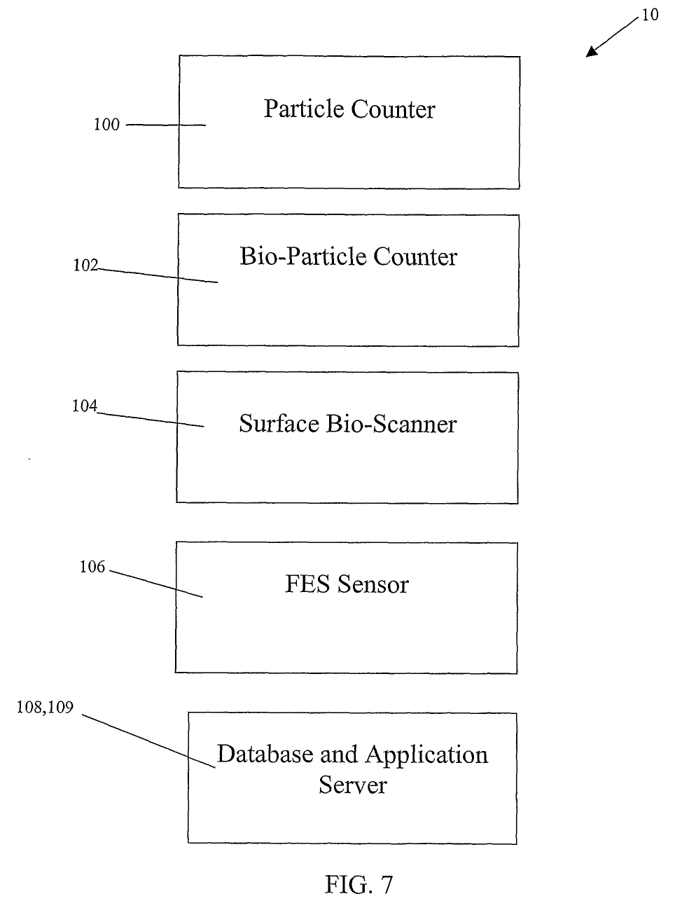

FIG. 7 shows an exemplary monitoring system 10 having a plurality of differently configured sensors connected to the system. A particle counter sensor 100 and a biological particle counter sensor 102 are constructed to monitor a fluid flow or the like. For example, in a medical facility, sensors 100, 102 could be located in a heating, ventilation, and air conditioning (HVAC) system to monitor for particulates carried on the flow. A surface biological sensor 104 is connected to monitoring system 10 and constructed to test surfaces such as walls, instruments, hands, catheters and the like for pollutants. Additionally, when configured in a remote operation configuration, surface biological sensor 104 is constructed to monitor pathogenic material in patients. Sensor 106 is a trainable sensor constructed to dynamically adjust operation of the sensor responsive to environmental stimuli.

Preferably, database 24 and server 78 are interconnected to a plurality of sensors 12, e.g., sensors 100, 102, 104, or 106, and are configured to monitor a desired area. Depending on the type of pollutant being monitored any combination of sensors 100, 102, 104, 106 may be formed to provide a desired monitoring of a environment. It is further understood and appreciated that sensors 100, 102, 104, 106 be intermixed on a monitoring network to provide a near complete pollutant determination of the area being scanned. It is further appreciated that the dispersion modality of the plurality of sensors 100, 102, 104, 106 provides a highly functional environmental monitoring system. That is, in those applications where installing a plurality of sensors is logistically impractical, it is envisioned that sensors 100, 102, 104, 106 be remotely delivered to the remote location and automatically dispersed at the location by, e.g., a remotely controlled vehicle. Regardless of the delivery means, the specific type of sensor utilized, and the number of sensors enabled, monitoring system 10 provides a dynamic, robust, and efficient means of monitoring an area for a plurality of quality factors.

An application server and database 108, 109 are connected to monitoring system 10 and configured to control and monitor the operation of sensors 100, 102, 104, 106 and record and monitor the information acquired therefrom, respectively. Application server 108 is configured to communicate the necessary instructions to each of sensors 100, 102, 104, 106 such that the sensors operate according to parameters correlating to the parameters they are configured to monitor. Application server 108 and database 109 are configured to monitor the number and identification of the sensors connected thereto. Such a configuration ensures that information of the system is secure and provides a dynamic monitoring system by allowing continuing inclusion and exclusion of sensors as determined by the operability of the sensors of the parameter desired to be acquired.

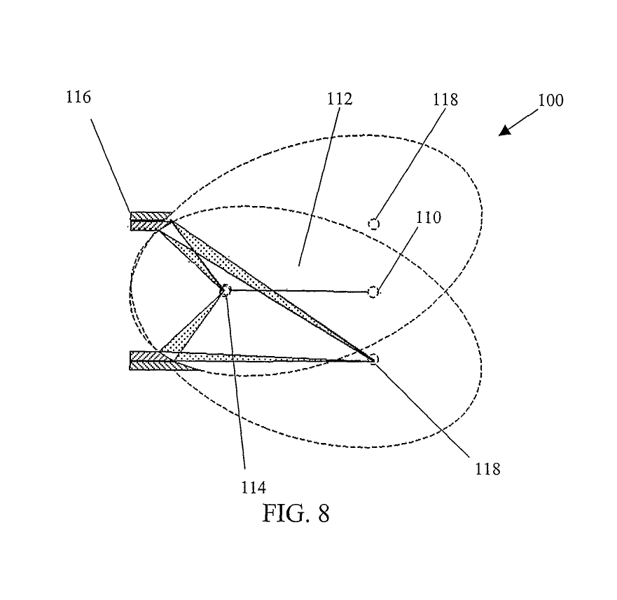

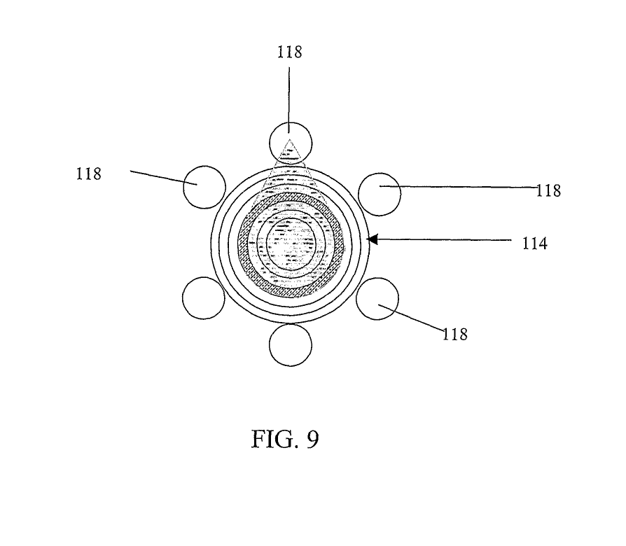

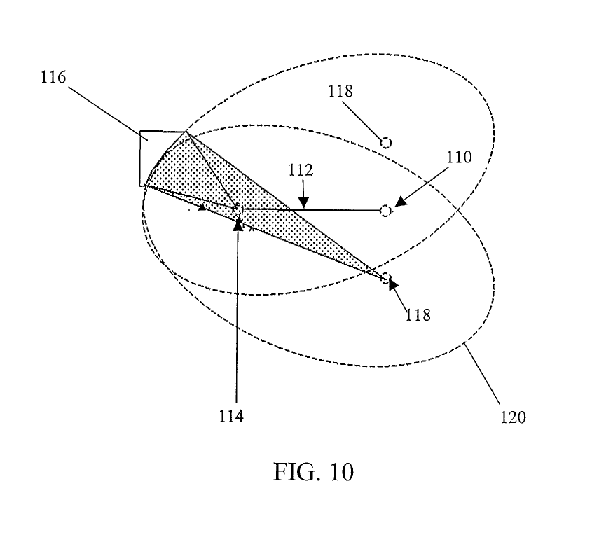

The sensors 100, 102, 104, 106 will now be discussed in greater detail. As previously stated, a monitoring system according to the present invention can include any number of sensors 100, 102, 104, 106 and any combination thereof. FIGS. 8-12 show particle counter sensor 100. Particle counter sensor 100 operates continuous in real-time and includes no consumables and is constructed to detect aerosol-borne organisms such as fungi, bacteria and other viable organisms. An emitter or source 110 emits radiation, indicated by line 112 that is focused onto a particle probe region 114. Radiation that impacts the particle is scattered and is reflected by an array of reflectors 116 onto a detector 118. Preferably, reflectors 116 are elliptically shaped and concentrically arranged about probe region 114. Preferably, detector 118 is a photo-detector and the particle probe region 114 and detector 118 are located at the foci of a reflector 116. An optical particle size can be calculated by analyzing the signal amplitudes at different scattering angles. Preferably, a low-cost detector 118 collects light reflected from each reflector 116. As shown in FIG. 9, positioning a plurality of detectors 118 about probe region 114 provides for acquisition of a majority of the energy associated with the impacting of the particle thereby allowing accurate determination of a particle type from a plurality of potential particle types. As shown in FIG. 10, focusing the radiation 112 emitted from source 110 onto the particle probe region 114 scatters radiation that is reflected by reflectors 116 onto detector 118. The particle probe region 114 and detector 118 are located at the foci of one of the elliptical reflectors 120.

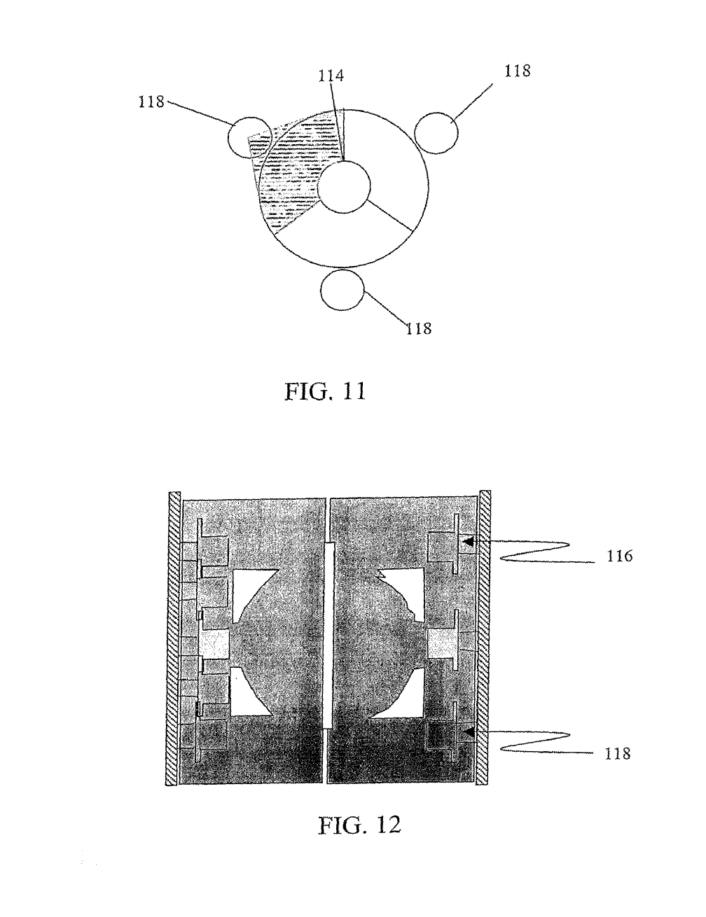

Referring to FIGS. 11 and 12, the arrangement of detectors 118 and reflectors 116 about the particle probe region 114 ensures expeditious identification of the particle passing thereby. By analyzing the signal amplitudes at different photo detectors 118, a shape, and thereby, the type of particle can be determined. The arrangement of elliptical reflectors and focusing of the energy scattering allows detector 118 to be very economical in construction. Preferably, the reflector is be made out of aluminized injection-molded plastic.

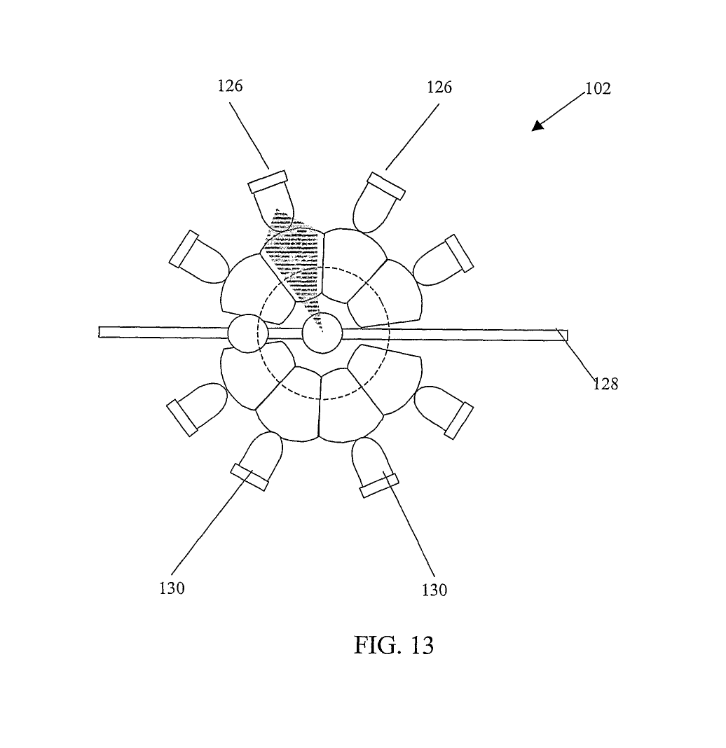

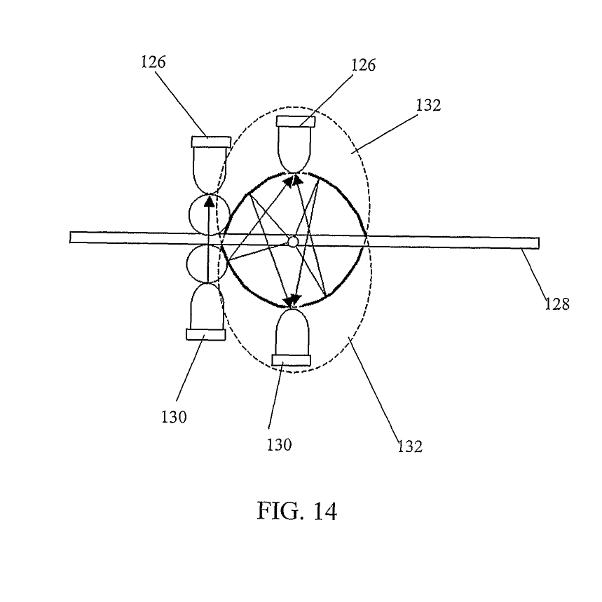

FIG. 13 shows an example of a biological particle counter sensor 102. Sensor 102 allows an ambient environment to be continuously monitored for potentially harmful biological aerosols, and particle fluorescence. When excited by radiation tuned to the principal biological fluorophores contained within biological organisms, intrinsic particle fluorescence can be used to help differentiate biological from non-biological particles and can even provide some discrimination between biological particles which are normal constituents of an ambient environment and those which may be considered a threat. However, because intrinsic fluorescence from biological fluorophores is generally weak, and because the fluorophores in airborne biological particles are normally present in extremely small quantities, the exciting radiation must be intense. However, solid-state harmonic lasers generally utilized for such excitation are relatively expensive and impractical where multiple-point detection or widespread field monitoring is desired. Sensor 102 includes a plurality of Ultra Violet (UV) laser emitting diodes (LEDs) and allows for a lightweight, transportable, and economical biological material sensor. Sensor 102 includes a plurality of UV LEDs 126 that are controlled to cause excitation by consecutively firing 280 nm and 370 nm UV LEDs using about ten times the rated current (200 mA) for extremely short periods of time (˜ns) resulting in 100 mW of optical power. Understandably, the values are merely preferable and exemplary. As particles pass sensor 102 along a flow, indicated by arrow 128, a detector 130 acquires signals associated with the scattering of bioparticles off of the particles. The detector 130 measures the induced fluorescence as the radiation contacts an elliptical reflector 132 as shown in FIG. 14. The reflected radiation is directed to detector, e.g., a photo-detector 130, and utilized to determine the nature of the particle passing proximate sensor 102. Sensor 102 a very cost effective means of detecting species of interest and compounds released in a given environment. Further, it can be trained to detect aerosol agents through its own on-board processor and is sensitive to the level of sub PPM (parts per million). Alternatively, sensor 102 could be constructed to simply communicate the acquired data to a remote controller.

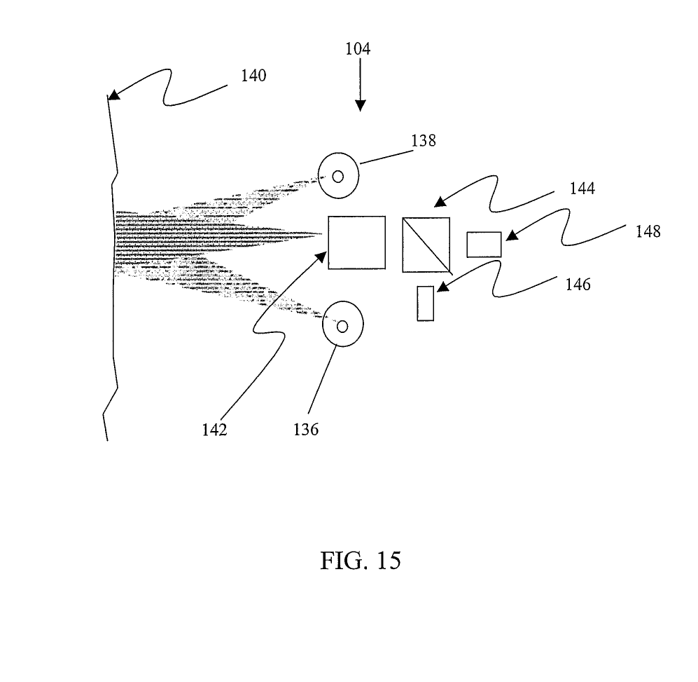

FIG. 15 shows an exemplary surface biological sensor 104. Sensor 104 is constructed to detect the presence of biological agents, for example Bacillus anthracis, or anthrax, on surfaces as well as distinguish between active and inactive variants of the agents. Sensor 104 is also constructed for remote and transportable operation of the sensor. Sensor 104 includes a pair of emitters 136, 138 configured to cause excitation in a particle of interest. Preferably, emitters 136, 138 are xenon flash tubes configured to emit a broad-spectrum light pulse that includes energy in the ultraviolet region. A filter (not shown) provides a narrow band emission centered around 280 nm of emitter 136. Emitter 138 emits a broad-spectrum light pulse that is filtered to a narrow band around 370 nm. The light pulse is incident on a surface 140 that is desired to be scanned. UV is absorbed by natural flouraphores in the biological material and re-emits energy in the visible spectral region. An integrating sphere/lens 142 collects the radiation and separates the incoming light into two components by a beam splitter 144. A first portion of the energy in the spectral region between X and Y is detected by a photo-sensor 146. A second portion of the energy is filtered to pass energy in the spectral region between Z and W. The second portion of the energy is detected by another photo-sensor 148. The pulse generated by emitter 136 and 138 is synchronized with the gating of the signal received at detectors 146 and 148 to measure the fluorescent lifetime of the emission. A combination of the fluorescent lifetime, the ratios of intensities from detector 146 and 148 and the particle size, yield a result that provides a highly specific identification of pathogenic and non-pathogenic biological material monitored with sensor 104. Operation of sensor 104 provides a continuous, real-time operating sensor that monitors a surface from a standoff distance. Accordingly, sensor 104 provides analysis of a surface without agitation of the surface that could result in sending polluting particles airborne and further polluting other surfaces. Sensor 104 is constructed to provide differentiation of viable pathogenic organisms from other biological material. Sensor 104 has applications to medicine, food services, the military, etc.

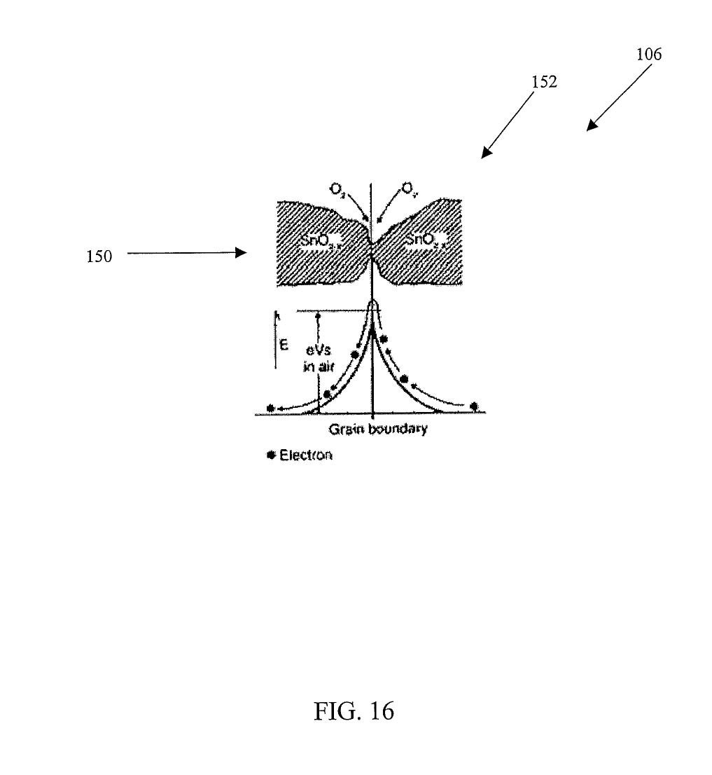

FIGS. 16-18 show an example of an operational protocol of another sensor according to the present invention. Sensor 106 is a biometric trainable sensor constructed to monitor values having ascertainable oxide values. It is capable of both environmental and medical monitoring.

Living organisms such as bacteria and fungi produce gaseous by-products of metabolism. A gas sensor can sense these gaseous species, which in some cases are toxic. The presence of such by-products is used as an indicator of the presence of a specific living organism. Similarly, humans produce gaseous by-products during metabolism. Various changes in the health of a human take place that results in changes in the species of the gaseous by-products and serves as a non-invasive indicator of toxicity and other healthcare quality parameters. As a healthcare tool, placement of sensor 106 on a cell-phone or other mobile personal electronic device allows convenient and comparatively constant monitoring of a health indicative parameter. Talking into the device causes breath gases to collect in the headspace of the device. Sensor 106 measures the gaseous by-products in this headspace and sends information to the sensor network for analysis.

Sensor 106 is of the type more commonly known as a metal oxide sensor (MOS) or Taguchi sensor. Such sensors include a surface active, grainy, semi-conductive oxide (usually SnO₂) based gas sensing film 150 that operates at elevated temperatures. The grain size of film 150 can be as small as 10 nanometers. The stochastic sensor signal is represented by the temporal microscopic fluctuations in the sensor resistance, and the ambient gas influences these fluctuations. The sensor's DC resistance is dominated by charge carrier transport through the potential barriers at inter-grain boundaries 152. The barrier is formed when the metal oxide crystal is heated in air, and oxygen is adsorbed which acts as a donor due to its negative charge. The barrier height is reduced when the concentration of oxygen ions decreases in the presence of a reducing gas. As a result, the DC resistance decreases. The resistance is typically used as a measure of the presence of a reducing gas. The relationship between sensor resistance and the concentration of deoxidizing gas can be expressed by the following equation over a certain range of gas concentration:

Rs=A[C]−a

where Rs=electrical resistance of the sensor; A=slope; [C]=gas concentration; and a=constant of Rs curve. Preferably, sensor 106 is fabricated by the simple casting of single-walled carbon nanotubes (SWNTs) on an interdigitated electrode (IDE). Sensor 106 responses are linear for concentrations of sub ppm to hundreds of ppm with detection limits of 44 ppb for NO2 and 262 ppb for nitrotoluene. The time is on the order of seconds for the detection response and minutes for the recovery. The extended detection capability from gas to organic vapors is attributed to direct charge transfer on individual semiconducting SWNT conductivity with additional electron hopping effects on intertube conductivity through physically adsorbed molecules between SWNTs. Such a construction provides a gas sensor that is highly responsive, does not consume excess power, is comparatively small, is operatively sensitive and robust.

The envisioned technological demonstration is built upon the understanding of stochastic processes present in the detection signals of traditional chemical sensors. Here, the fluctuation activity has been shown to contain valuable sensor information that can be obtained not only by spectral analysis but also by methods of higher-order statistics. Indeed, the interaction between a chemical sensor and the molecules it detects is always a dynamic stochastic process. Furthermore, stochastic fingerprinting of breath is an indicator of health condition. The above-described process may be represented by the following chemical equations:

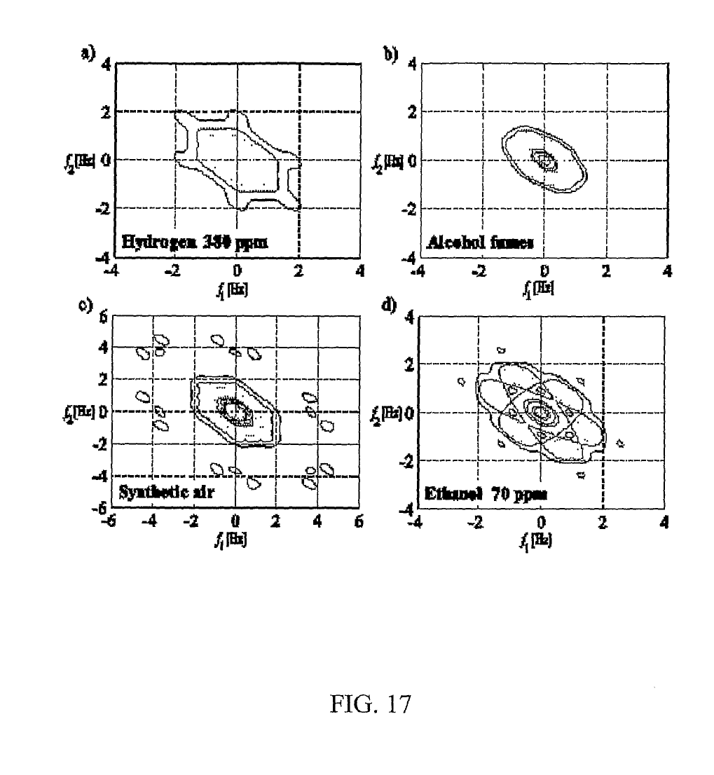

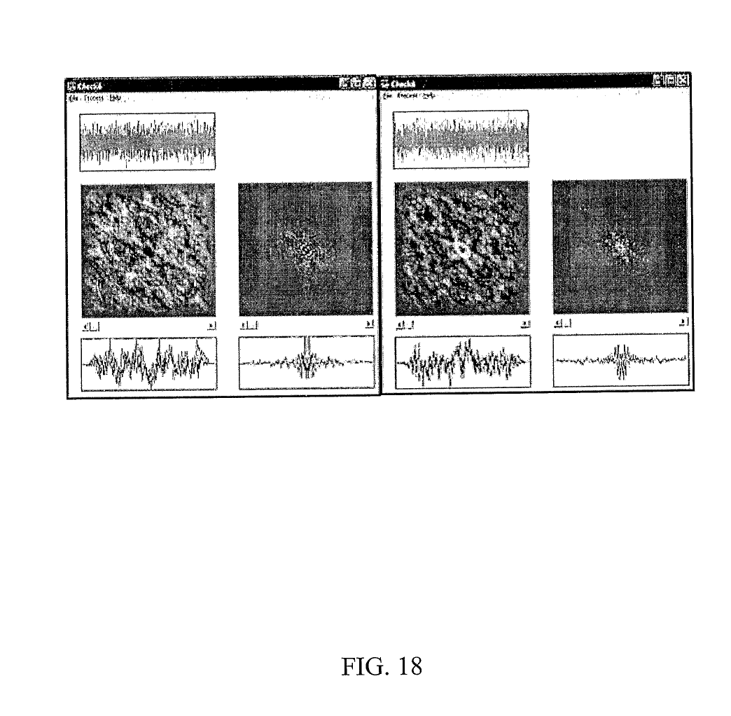

Variations in the readings of sensor 106 are indicative of a “stochastic fingerprint” of the chemicals (and potentially also from interacting biological molecules) that arise from the time-dependent interactions with the sensor. Rather than simply acquiring a mean value, sensor 106 is constructed to acquire a range of inputs generally proximate the mean value. Such a construction allows sensor 106 to determine a particle type with a great degree of specificity. As shown in FIGS. 17 and 18, the signal generated by sensor 106 is configured to generate a signal indicative of a particular particle being sensed. Sensor 106 is constructed to account for the micro-fluctuations present in the sensor and operates under fluctuation-enhanced sensing (FES) that utilizes the micro-fluctuations already present in the sensor and that are influenced by very low concentrations of chemical (and also potentially by biological) agents.

The sensitivity and selectivity of sensor 106 is constructed for detection of particles down to parts per trillion levels. These improvements are due in part to the fact that stochastic information acquired from sensor 106 was utilized to estimate concentrations and to achieve identification of chemical species. Small arrays of sensors further improve performance and reliability. That is, if a sample of a known particle is acquired and analyzed with sensor 106, sensor 106 can be configured to identify the “fingerprint” of the tested particle. Accordingly, sensor 106 is constructed to provide a non-invasive, continuous, real-time, low cost, highly portable, robust, and trainable sensor. Oxidative stress is a general indicator of disease or exposure to toxic substances. Thus, detecting various manifestations of oxidative stress could be used as a preliminary screening for toxic exposure. Accordingly, human breath analysis sensing is an inexpensive, non-invasive means of monitoring health conditions.

As mentioned, a monitoring system according to the present invention preferably includes many different sensors and an innumerable number of sensor orientations and configurations per monitoring environment or event. For example, the monitoring system includes multiple user configurable alarm levels, a robust construction operable between approximately −20 C° and approximately +70 C°, and a number of operating power ranges from low voltages to at least 120 V operation input. Preferably, the monitoring system includes an IEEE 802.3 (Ethernet) or wireless communication interface and each sensor is uniquely identified to allow expedient identification of alert or alarm conditions. Preferably, sensors 100, 102, 104, 106 are interchangeable and combinable in any format with monitoring system 10 and allow for remote and secure communication with the monitoring system. The system preferably includes a database constructed to monitor and record operation of the sensors of the systems.

Monitoring system 10 and sensors 100, 102, 104, 106 provide a highly dynamic and flexible monitoring system. The monitoring system can include any combination of sensors 100, 102, 104, 106 and any number thereof. Understandably, the number of sensors, the dispersion of the sensors, and the diversity of the sensors connected to the network all contribute to the definition of the sensed parameters as well as the geographic area defined for monitoring. Understandably, incorporation of any of sensors 100, 102, 104, 106 into a prolific device such as cell phones or other personal devices including vehicles or computers, whether movable or not, would provide a far reaching and responsive monitoring system.

Although the best mode contemplated by the inventor of carrying out the present invention is disclosed above, practice of the present invention is not limited thereto. It will be manifest that various additions, modifications and rearrangements of the features of the present invention may be made without deviating from the spirit and scope of the underlying inventive concept. In addition, the individual components need not be fabricated from the disclosed materials, but could be fabricated from virtually any suitable materials. Moreover, the individual components need not be formed in the disclosed shapes, or assembled in the disclosed configuration, but could be provided in virtually any shape, and assembled in virtually any configuration. Further, although the modules described herein are physically separate, it will be manifest that they may be integrated into the apparatus with which it is associated. Furthermore, all the disclosed features of each disclosed embodiment can be combined with, or substituted for, the disclosed features of every other disclosed embodiment except where such features are mutually exclusive.

What we claim is:

1. A monitoring system (10) comprising:
a processor (22, 26) having a database (24);
at least one sensor (12, 100, 102, 104, 106) for communicating a monitored parameter to the database (24); and
a controller (14) connected to the processor (22, 24) and the at least one sensor (12, 100, 102, 104, 106) and configured to control operation of the at least one sensor based on a history of monitored parameters.

2. The monitoring system (10) of claim 1 wherein the sensor (12, 100, 102, 104, 106) further comprises an input configured to power the sensor (12, 100, 102, 104, 106) and connectable to at least one of an Ethernet, Internet, a LAN, and an intranet.

3. The monitoring system (10) of claim 1 wherein the sensor (12, 100, 102, 104, 106) further comprises a first exciter (110, 126) configured to operate at a first frequency and a second exciter (110, 126) configured to operate at a second frequency different than the first frequency.

4. The monitoring system (10) of claim 3 wherein the first and second exciters (110, 126) are at least one of a flash tube having at least a portion of ultraviolet emission and an ultra-violet LED.

5. The monitoring system (10) of claim 4 wherein the processor (26, 36) is configured to synchronize firing of the exciters (110, 126) and gating of a pair of detectors (118).

6. The monitoring system (10) of claim 5 wherein the processor (26, 36) is configured to determine a particle fluorescent lifetime, an intensity ratio between the pair of detectors (118), and a particle size to identify the particle.

7. The monitoring system (10) of claim 1 wherein the sensor (12, 100, 102, 104, 106) further comprises an elliptical reflector (116) configured to direct forward scattered particle radiation to a photo-detector (118).

8. The monitoring system (10) of claim 7 wherein the photo-detector (118) and a probe region (114) are oriented at the foci of the elliptical reflector (116).

9. The monitoring system (10) of claim 1 wherein the sensor (12, 100, 102, 104, 106) is a metal-oxide sensor and the processor (26, 36) is configured to acquire an output value of the metal-oxide sensor and a signal range generally proximate the output value.

10. The monitoring system (10) of claim 9 wherein the processor (26, 36) is configured to compare the acquired output value and the signal range to the history and at least one of adjust operation and maintain operation of the sensor (12, 100, 102, 104, 106) as determined by the comparison.
